(19) United States
(12) Patent Application Publication
(10) Pub. No.: US 2010/0177680 A1
(43) Pub. Date: Jul. 15, 2010

(54) SYSTEM AND METHOD OF DELIVERING CONTENT USING NETWORKED WIRELESS COMMUNICATION UNITS

(75) Inventors: Larry G. Fischer, Waseca, MN (US); Jamie Brown, Prior Lake, MN (US); Mahesh Patel, Streamwood, IL (US); Tony Lefebvre, Edina, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/351,048

(22) Filed: Jan. 9, 2009

(51) Int. Cl. H04W 4/00

(52) U.S. Cl. 370/328

(57) ABSTRACT

A wireless network comprises a plurality of areas of interest and a core network coupled to each of the plurality of areas of interest to route real-time data from each of the plurality of areas of interest. Each of the plurality of areas of interest includes a plurality of wireless communication units. Each wireless communication unit comprises a local cache to store non-real-time data; and a gateway to process non-real-time data requests and provide an interface to a packet network. The plurality of wireless communication units in each of the plurality of areas of interest are networked together such that each wireless communication unit has access to data stored on the local cache of another of the plurality of wireless communication units, wherein the gateway in each of the plurality of wireless communication units is operable to provide the requested non-real-time data, if available, from one of its local cache and the cache of other wireless communication units prior to passing the non-real-time data request to the packet network.

### CROSS-REFERENCE TO RELATED APPLICATIONS

This application is related to the following co-pending United States patent applications filed on even date herewith, all of which are hereby incorporated herein by reference:

U.S. patent application Ser. No. ______ (attorney docket number 100.917US01 entitled “SYSTEM AND METHOD OF DELIVERING CONTENT FROM A WIRELESS COMMUNICATION UNIT”) and which is referred to herein as the '917 Application;

U.S. patent application Ser. No. ______ (attorney docket number 100.918US01 entitled “SYSTEM AND METHOD OF DELIVERING CONTENT OVER A LOCAL WIRELESS SYSTEM”) and which is referred to herein as the '918 Application;

### BACKGROUND

Wireless communication has become increasingly popular and accessible. In particular, wireless technology is currently available which enables a user to access and receive non-real-time data over a wireless network using a wireless device such as a cell phone or a laptop computer. For example, users can access the internet, email, etc. using a wireless device. Non-real-time data, such as web pages, music, etc. is typically stored on content servers and accessed via a data network such as the internet

However, the ability to access non-real-time data is placing increasing burdens on the available bandwidth of conventional wireless networks such as GSM networks. The increased bandwidth burden may lead to more dropped calls and poorer service quality similar to the problems experienced by landline telephone service providers shortly after the advent of internet access via phone lines. One possible solution to the problem of bandwidth burden is to limit or cut off access to non-real-time data for users with high-volumes of non-real-time data traffic. This solution, however, may cause a decline in subscribers and does not answer the growing demand for access to non-real-time data over wireless networks.

For the reasons stated above and for reasons that shall become apparent to one of ordinary skill in the art upon reading and studying the present application, there is a need in the art for a system which relieves the burden placed on wireless networks to access stored non-real-time data.

### SUMMARY

In one embodiment, a wireless network is provided. The wireless network comprises a plurality of areas of interest and a core network coupled to each of the plurality of areas of interest to route real-time data from each of the plurality of areas of interest. Each of the plurality of areas of interest includes a plurality of wireless communication units. Each wireless communication unit comprises a local cache to store non-real-time data; and a gateway to process non-real-time data requests and provide an interface to a packet network. The plurality of wireless communication units in each of the plurality of areas of interest are networked together such that each wireless communication unit has access to data stored on the local cache of another of the plurality of wireless communication units, wherein the gateway in each of the plurality of wireless communication units is operable to provide the requested non-real-time data, if available, from one of its local cache and the cache of other wireless communication units prior to passing the non-real-time data request to the packet network.

### DRAWINGS

FIG. 1 a block diagram showing one embodiment of a wireless network.

FIG. 2 is a block diagram showing an exemplary configuration of an area of interest.

FIG. 3 is a block diagram showing another exemplary configuration of an area of interest.

FIG. 4 is a block diagram of another exemplary configuration of an area of interest.

FIG. 5 is a flow chart depicting one embodiment of a method of providing non-real-time data to a wireless device in an area of interest.

FIG. 6 is a flow chart of one embodiment of a method of caching non-real-time data in a wireless communication unit.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures or the specification is not to be construed as limiting the order in which the individual steps may be performed. The following detailed description is, therefore, not to be taken in a limiting sense.

Some embodiments reduce the bandwidth burden placed on a wireless network due to non-real-time data traffic. In particular, some embodiments enable delivery of cached non-real-time data traffic to a wireless device from a wireless communication unit without the need to retrieve the non-real-time data from a content server over the wireless network. In addition, some embodiments enable the efficient caching of data to relieve the bandwidth burden.

As used herein, real-time data is defined as data which is transmitted at substantially the same time as it is created, such as voice data and text messages. Hence, non-real-time data, such as web pages, music, etc., is defined as data which is not transmitted at substantially the same time as it is created. In other words, non-real-time data is data which is stored for later access or transmission.

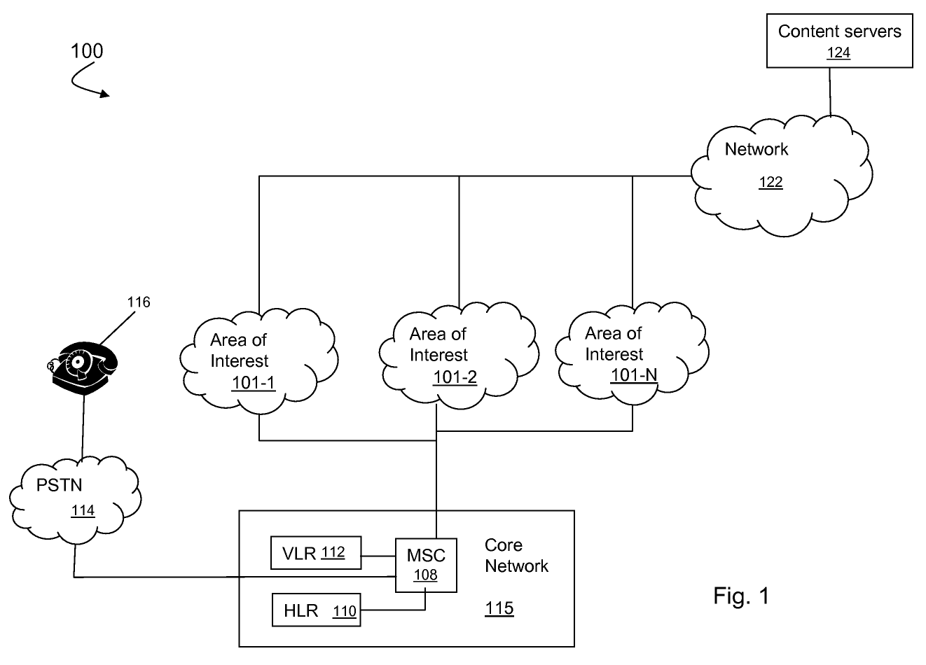

FIG. 1 is a block diagram of one embodiment a wireless network 100. Network 100 reduces the bandwidth burden for delivery of non-real-time content to wireless devices compared to a conventional wireless networks. Exemplary wireless devices include mobile phones, personal digital assistants (PDA), laptops, and any other device configured to connect to wireless network 100. In particular, network 100 includes a plurality of areas of interest 101-1 . . . 101-N. An area of interest 101 is a geographical sub-division within network 100 in which a plurality of mobile devices are located. Exemplary areas of interest include, but are not limited to, shopping centers, college campuses, cities, etc.

Each area of interest 101-1 . . . 101-N includes a distributed packet gateway as described in more detail below. Thus, each area of interest is coupled directly to a packet switched network 122, such as the internet, via its distributed packet gateway and to a circuit switched network 114, such as the public switched telephone network (PSTN), via a core network 115. Thus, bandwidth burdens placed on the core network 115 are reduced. In this exemplary embodiment, network 100 is a Global System for Mobile communications (GSM) network and core network comprises a mobile switching center (MSC) 108, visitor location register (VLR) 112, and home location register (HLR) 110.

Although the exemplary embodiments are described herein with respect to a Global System for Mobile communications (GSM) network, it is to be understood that other embodiments can be implemented using other network technologies. For example, other embodiments implement Universal Mobile Telecommunications System (UMTS), Worldwide Interoperability for Microwave Access (WiMAX), Code Division Multiple Access 2000 (CDMA2000), Ultra Mobile Broadband (UMB), and Long Term Evolution (LTE).

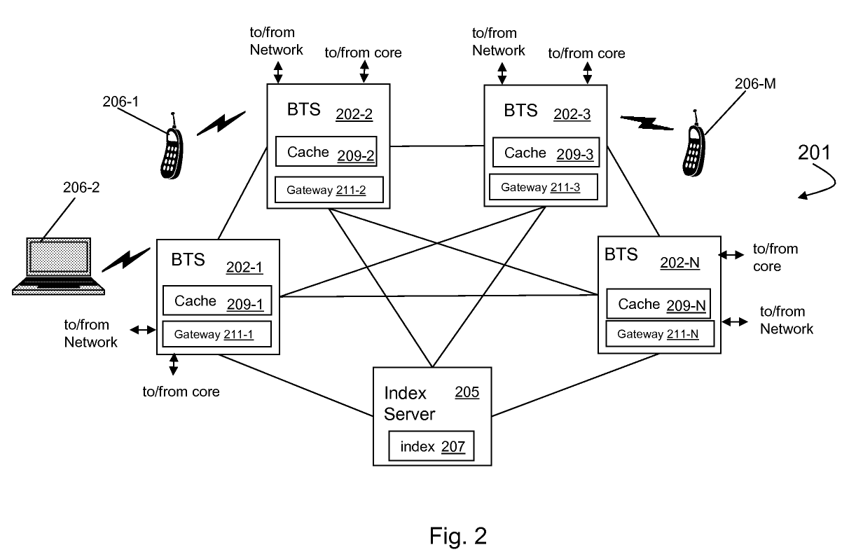

An exemplary configuration of an area of interest 101 is shown in FIG. 2. Area of interest 201 includes wireless communication units 202-1 . . . 202-N configured to transceive wireless signals to/from wireless devices 206-1 . . . 206-M. Although only five wireless communication units 102 are shown in FIG. 2 for purposes of explanation, it is to be understood that any appropriate number of wireless communication units 202 can be used in other embodiments.

Notably, the wireless communication units 202 in this exemplary embodiment are implemented as GSM base station transceivers (BTS). However, as described above, it is to be understood that other wireless technologies can be used in other embodiments. For example, wireless communication units 202-1 . . . 202-N can be implemented as Radio Network Controllers (RNC) in a UMTS network or as Access Service Network (ASN) Base Stations (BS) in a WiMAX network.

In addition, each wireless communication unit 202-1 . . . 202-N is also configured to implement functionality of a conventional base station controller. In addition, each wireless communication unit 202-1 . . . 202-N includes a gateway 211-1 . . . 211-N. Gateway 211 in each wireless communication unit 202 processes data packets and provides an interface to the packet data network 122. For example, in the exemplary embodiment of FIG. 2, gateway 211 in each wireless communication unit 202 implements the functionality of a Serving General Packet Radio Service (GPRS) Support Node (GGSN) and a Gateway GPRS Support Node (GGSN). The gateway node functionality can be implemented as a plurality of computational cards each with a specific function. In other embodiments, gateway 211 implements gateway node functionality appropriate for other wireless technologies. For example, in an alternative embodiment in which a WiMAX network is used, gateway 211 implements the functionality of an Access Service Network (ASN) gateway. Thus, including gateway 211 in each wireless communication unit 202-1 . . . 202-N distributes the gateway node in area of interest 201, whereas conventional wireless network utilize a centralized gateway node for a plurality of communication units.

Each wireless communication unit 202 passes real-time data to the core network 115. In addition, each wireless communication unit 202 includes a local cache 209. Gateway 211 in each wireless communication unit 202 processes user initiated requests for non-real time data received from wireless devices 206-1 . . . 206-M. In processing the data requests, gateway 211 determines if the requested data is stored in the local cache 209 coupled to gateway 211 in the respective wireless communication unit 202. If the requested data is located in cache 209, the requested data is provided to the wireless device 206 from cache 209 rather than over the network 100 from content servers 124. Thus, the bandwidth burden on the network 100 associated with non-real-time data, such as video and music files, is reduced.

The non-real-time data to be stored in each cache 209-1 . . . 209-N is selected, in some embodiments, based on actual requests received from wireless devices 206-1 . . . 206-M. For example, in one embodiment, cache 209-1 . . . 209-N are updated by deleting the last accessed data with more recently accessed data. In this way, data that is requested more often is kept in cache to improve performance. In other embodiments, the data to be stored is also determined by anticipating requests. In other words, if a history of requests indicates that a particular file or data is typically requested frequently, cache 209-1 . . . 209-N can store that data prior to any actual requests in anticipation of the frequent requests. For example, if a history of requests indicates that a given news site is accessed by many users each morning, each wireless communication unit 202-1 . . . 202-N caches the given news site each morning prior to receiving any requests in anticipation of requests for the news site.

In addition, wireless communication units 202-1 . . . 202-N are networked together such that each wireless communication unit 202-1 . . . 202-N is able to access the data stored in the respective cache 209 of other networked wireless communication units 202-1 . . . 202-N. For example, in one embodiment, the wireless communication units are networked together using the Internet Protocol (IP). If the requested data is not stored in cache 209-1, wireless communication unit 202-1 determines if the requested data is stored in one of cache 209-2 . . . 209-N associated with wireless communication units 202-2 . . . 202-N, respectively, prior to sending the request upstream over packet network 122 to retrieve the data from content servers 124.

As used herein, the term “upstream” refers to the direction of data traffic from wireless devices 206-1 . . . 206-M to content servers 124. Similarly, the term “downstream” refers to the direction of data traffic from content servers 124 to wireless devices 206-1 . . . 206-M. Therefore, wireless communication units 202-1 . . . 202-N relieve the bandwidth burdens placed on network 100 due to the bandwidth demands placed on network 100 by non-real-time data traffic.

Furthermore, whereas in some embodiments, each wireless communication unit 202-1 . . . 202-N independently determines which data to store in its respective cache 209-1 . . . 209-N, in other embodiments, wireless communication units 202-1 . . . 202-N work in conjunction to avoid unnecessary repetition of stored data. In particular, prior to storing data in its respective cache, each wireless communication unit 202-1 . . . 202-N determines if the data is already stored in another cache 209 associated with a networked wireless communication unit 202-1 . . . 202-N. In this manner, the total memory available for caching data is maximized since data is not duplicated on multiple caches 209-1 . . . 209-N.

In order to coordinate sharing data stored in each of caches 209-1 . . . 209-N, an index server 205 is used in the embodiment shown in FIG. 2. Index server 205 maintains an index 207 which identifies the data stored in each of caches 209-1 . . . 209-N. Each of wireless communication units 202-1 . . . 202-N accesses index server 205 when determining if requested data is stored in a cache 209 associated with another wireless communication unit 202. For example, if wireless communication unit 202-1 receives a request for data not stored in its associated cache 209-1, wireless communication unit 202-1 accesses index server 205 to determine if the data is stored in another cache. If the data is stored in a cache 209 associated with another wireless communication unit 202, index server 205 provides wireless communication unit 202-1 with the necessary information, such as an IP address, to enable wireless communication unit 202-1 to contact the corresponding wireless communication unit and retrieve the requested data. In other embodiments, index server 205 performs routing functions to route the request to the appropriate wireless communication unit 202. In such embodiments, index server 205 functions similar to a hub in a star network configuration.

If the data is not stored in a cache 209 associated with another wireless communication unit 202, index server 205 indicates to wireless communication unit 202-1 that the data is not currently located in any of caches 202-2 . . . 202-N. wireless communication unit 202-1 then sends the data request upstream to retrieve the data from content servers 124.

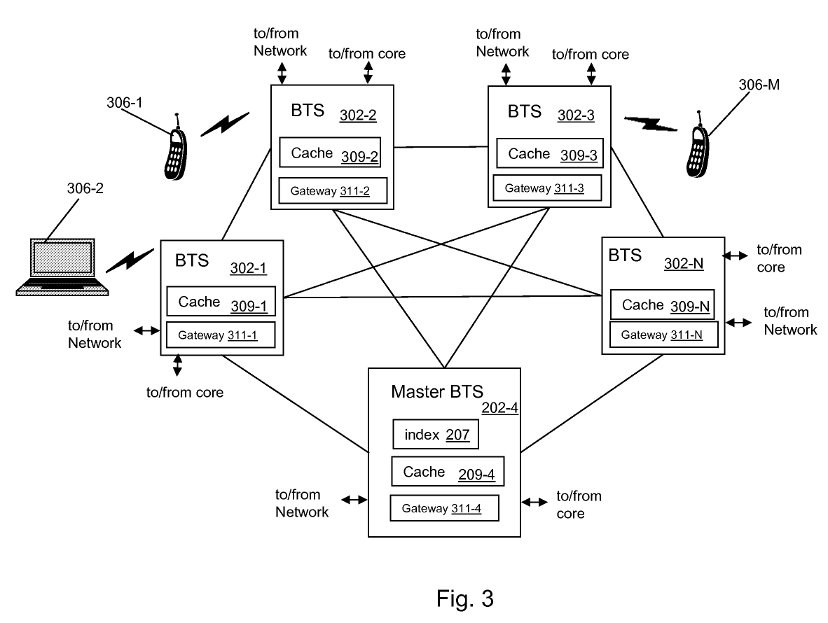

Another exemplary embodiment of an area of interest 301 is shown in FIG. 3. Area of interest 301 includes a master wireless communication unit 302-4. Master wireless communication unit 302-4 performs the function of transmitting/receiving signals from wireless devices 306-1 . . . 306-N as well as indexing the data stored in caches 309-1 . . . 309-N. In network 300, sharing of data stored in caches 309-1 . . . 309-N is coordinated by master wireless communication unit 302-4. In particular, wireless communication unit 302-4 routes requested data between wireless communication units 302-1 . . . 302-N.

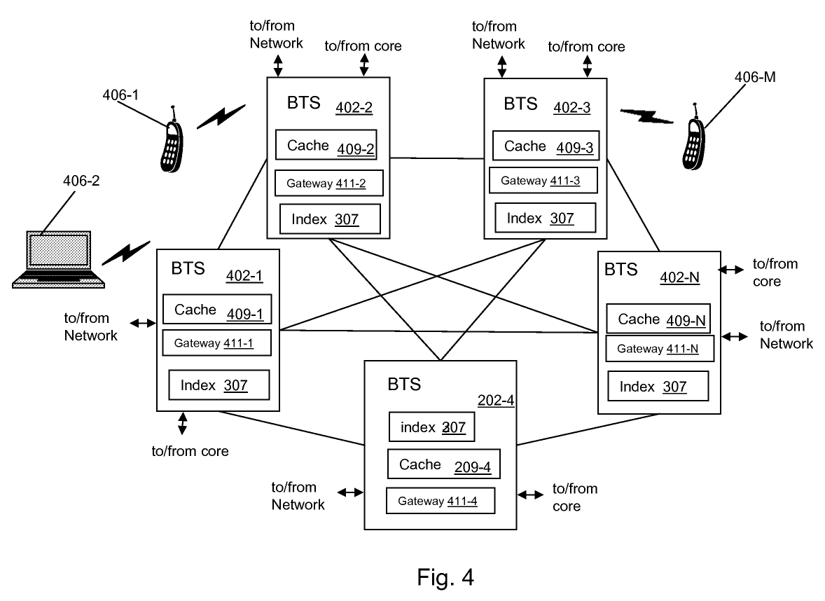

In other embodiments, such as the exemplary area of interest 401 shown in FIG. 4, each wireless communication unit 402-1 . . . 402-N maintains a copy of index 407. Each time the data stored on one of caches 409-1 . . . 409-N changes, each copy of index 407 in wireless communication unit 402-1 . . . 402-N is updated. For example, in one embodiment, each wireless communication unit 402-1 . . . 402-N notifies the other wireless communication units 402-1 . . . 402-N when an update is made to its respective cache 409-1 . . . 409-N. In other embodiments, each wireless communication unit 402-1 . . . 402-N periodically sends requests to the other wireless communication units 402-1 . . . 402-N to determine if changes have occurred since the previous request for changes. In the embodiment of FIG. 4, each wireless communication unit 402-1 . . . 402-N checks its own copy of index 407 to determine if requested data is stored in one of caches 409-1 . . . 409-N rather than checking a master copy stored on an index server or master wireless communication unit. In some such embodiments, wireless communication units 402-1 . . . 402-N communicate changes to index 407 via the well known IP protocol.

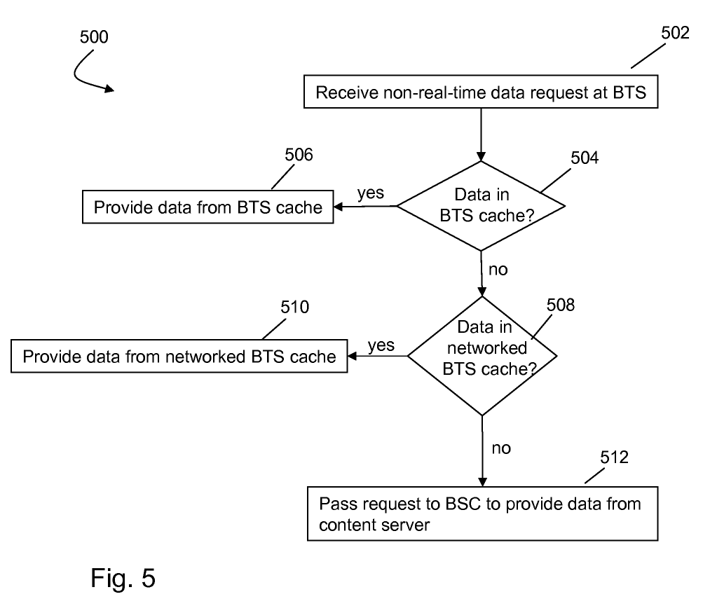

FIG. 5 is a flow chart depicting one embodiment of a method 500 of providing non-real-time data to a wireless device in an area of interest such as areas of interest 200, 300, and 400. At block 502, a request from a wireless device for non-real-time data is received at a first wireless communication unit, such as wireless communication unit 202 above. The first wireless communication unit processes the request to determine if the non-real-time data is stored in its associated cache (e.g. cache 209) at 504. If the data is located in the first wireless communication unit's associated cache, the first wireless communication unit provides the requested data to the wireless device from its associated cache at 506.

If the requested data is not stored in the first wireless communication unit's associated cache, the first wireless communication unit determines if the requested data is stored in the cache of a second wireless communication unit that is networked with the first wireless communication unit at 508. For example, in one embodiment, the first wireless communication unit sends the request to an index server (e.g. index server 205) which maintains an index of all stored data in the cache of each of a plurality of networked wireless communication unit. The wireless communication unit evaluates the index on the index server to determine if the requested data is stored in the cache of the networked wireless communication unit. In another embodiment, the first wireless communication unit sends the request to a master wireless communication unit which also maintains an index of all stored data in the cache of each of the plurality of networked wireless communication unit as described above. The master wireless communication unit determines if the requested data is stored in the cache of another wireless communication unit as described above. In yet another embodiment, the first wireless communication unit evaluates a local copy of an index of the stored data in each of one or more other wireless communication units networked with the first wireless communication unit. The local copy of the index stored in the first wireless communication unit is updated whenever changes are made to the data stored in the cache of the one or more other networked wireless communication units. For example, in one embodiment, the first wireless communication unit periodically requests updates regarding the contents of the cache of the one or more other networked wireless communication units. Alternatively, each of the one or more other networked wireless communication units provide notification to the first wireless communication unit whenever a change is made to the respective cache of the one or more other networked wireless communication units.

If it is determined that the requested data is stored in the cache of a second networked wireless communication unit, the requested data is provided to the wireless device from the cache of the second networked wireless communication unit at 510. For example, the first wireless communication unit communicates directly with the second wireless communication unit to provide the requested data in one embodiment. In another embodiment, the requested data is routed from the second wireless communication unit to the first wireless communication unit via an index server or a master wireless communication unit.

If the requested data is not stored in the cache of a second networked wireless communication unit, the first wireless communication unit passes the request to a BSC in order to retrieve the requested data from content servers (e.g. content servers 124) at 512. In particular, the BSC processes the request and communicates with a SGSN to obtain the requested data. By retrieving the requested data from the first wireless communication unit's cache or from the cache of a networked wireless communication unit, the bandwidth demands placed on the core network for non-real-time data are reduced.

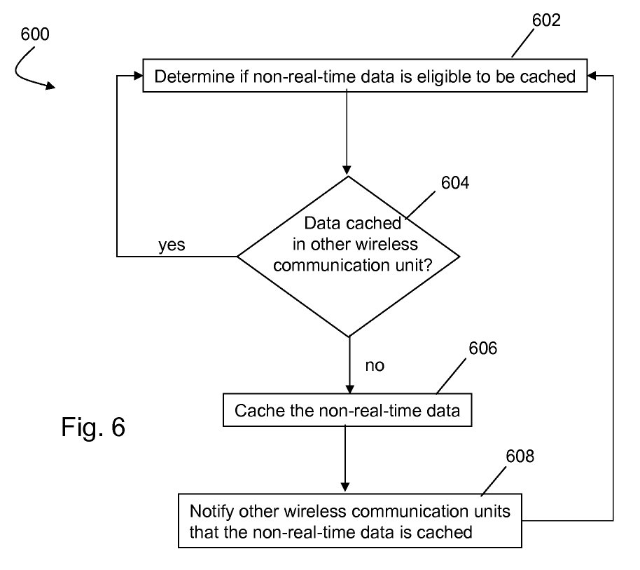

FIG. 6 is a flow chart of a method 600 of caching non-real-time data in a wireless communication unit (e.g. wireless communication unit 202). At 602, the wireless communication unit determines if a given non-real-time data file is eligible to be cached. For example, in some embodiments, a web page, music file, or other non-real-time data file is cached if the number of requests for the non-real-time data file exceeds a pre-determined number of requests. In other embodiment, other criteria may also be used, such as the type of non-real-time data. For example, in some embodiments, non-real-time data which changes frequently, such as a news feed, has a higher pre-determined number of requests than non-real-time data which changes infrequently, such as music or video file. Other factors include, but are not limited to, the size of the non-real-time data and whether or not a license is available to cache copyrighted non-real-time data.

At 604, if the non-real-time data file is eligible to be cached, the wireless communication unit determines if the non-real-time data file is already cached on another wireless communication unit. For example, in some embodiments, the wireless communication unit sends a request to a master wireless communication unit (e.g. master wireless communication unit 302-4) or to an index server (e.g. index server 205) to determine if the non-real-time data file is already cached. In other embodiments, the wireless communication unit compares the non-real-time data file to a local index of the non-real-time data cached on the other wireless communication units networked to the wireless communication unit.

At 606, if the non-real-time data file is not cached on any other wireless communication unit, the wireless communication unit caches the non-real-time data in its local cache. At 608, the wireless communication unit notifies the other wireless communication units that the non-real-time data file has been cached. For example, in one embodiment, the wireless communication unit sends a notification to each of the other wireless communication units in order to update the index of each of the other wireless communication units. In other embodiments, the wireless communication unit sends a notification to an index server or master wireless communication unit to update the master index. In this way, a plurality of wireless communication units coupled together are able to maximize the amount of data available for caching non-real-time data by not duplicating unnecessarily the cached non-real-time data.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the embodiments described herein. Therefore, it is manifestly intended that this invention be limited only by the claims and the equivalents thereof.

What is claimed is:

1. A wireless network comprising:
a plurality of areas of interest; and
a core network coupled to each of the plurality of areas of interest to route real-time data from each of the plurality of areas of interest;
wherein each of the plurality of areas of interest includes a plurality of wireless communication units, each wireless communication unit comprising:
a local cache to store non-real-time data; and
a gateway to process non-real-time data requests and provide an interface to a packet network;
wherein the plurality of wireless communication units in each of the plurality of areas of interest are networked together such that each wireless communication unit has access to data stored on the local cache of another of the plurality of wireless communication units; and
wherein the gateway in each of the plurality of wireless communication units is operable to provide the requested non-real-time data, if available, from one of its local cache and the cache of other wireless communication units prior to passing the non-real-time data request to the packet network.

2. The wireless network of claim 1, wherein each area of interest further comprises an index server coupled to the plurality of wireless communication units, the index server operable to maintain an index of the data stored on the local cache of each of the plurality of wireless communication units, wherein each of the plurality of wireless communication units determines if the requested data is stored on the cache of another of the plurality of wireless communication units by communicating with the index server.

3. The wireless network of claim 1, wherein one of the plurality of wireless communication units in each of the areas of interest is a master wireless communication unit operable to maintain an index of the data stored on the cache of each of the plurality of wireless communication units in the respective area of interest, wherein each of the plurality of wireless communication units determines if the requested data is stored on the cache of another of the plurality of wireless communication units by communicating with the master wireless communication unit.

4. The wireless network of claim 1, wherein each of the plurality of wireless communication units is configured to maintain a copy of an index of the data stored on the local cache of each of the plurality of wireless communication units in its respective area of interest, wherein each of the plurality of wireless communication units uses its copy of the index to determine if the requested data is stored on the local cache of another of the plurality of wireless communication units in its respective area of interest.

5. The wireless network of claim 4, wherein each of the plurality of wireless communication units is configured to notify the other wireless communication units if its respective local cache is updated.

6. The wireless network of claim 4, wherein each of the plurality of wireless communication units is configured to send periodic requests for updates to each of the other wireless communication units to determine if any of the respective local caches of the other wireless devices has been updated.

7. The wireless network of claim 1, wherein the wireless network is one of a Global System for Mobile communications (GSM) network, a Universal Mobile Telecommunications System (UMTS) network, a Worldwide Interoperability for Microwave Access (WiMAX) network, a Code Division Multiple Access 2000 (CDMA2000) network, an Ultra Mobile Broadband (UMB) network, and a Long Term Evolution (LTE) network.

8. A wireless communication unit comprising:
a local cache to store non-real-time data;
an index to store information regarding the non-real-time data stored on the local cache and on a cache of each of a plurality of other wireless communication units coupled to the wireless communication unit; and
a gateway to process requests for non-real-time data received from one of the plurality of other wireless communication units to determine if the requested non-real-time data is stored on one of the local cache and the cache of one of the other wireless communication units.

9. The wireless communication unit of claim 8, wherein the gateway is further operable to retrieve the requested non-real-time data from the cache of the corresponding wireless communication unit, if available, and to provide the requested non-real-time data to the wireless communication unit which requested the non-real-time data.

10. The wireless communication unit of claim 8, wherein the gateway is further operable to provide information to the wireless communication unit which requested the non-real-time data such that the requesting wireless communication unit is able to communicate with the wireless communication unit which has the requested data stored in its respective cache.

11. The wireless communication unit of claim 10, wherein the information provided is the Internet Protocol (IP) address of the wireless communication unit which has the requested data stored in its respective cache.

12. The wireless communication unit of claim 8, wherein the wireless communication unit is a Global System for Mobile communications (GSM) base transceiver station.

13. A method of providing non-real-time data to a wireless device in a network, the method comprising:
receiving a request for non-real-time data from the wireless device at a first wireless communication unit having a cache;
determining if the requested non-real-time data is stored in the cache of the first wireless communication unit;
if the requested data is stored in the cache of the first wireless communication unit, providing the requested non-real-time data to the wireless device from the cache of the first wireless communication unit;
if the requested non-real-time data is not stored in the cache of the first wireless communication unit, determining if the requested non-real-time data is stored in a cache of one of a plurality of other wireless communication units coupled to the first wireless communication unit;
if the requested non-real-time data is stored in the cache of one of the other wireless communication units, providing the requested non-real-time data to the wireless device from the cache of the corresponding other wireless communication unit;
if the requested non-real-time data is not stored in the cache of one of the other wireless communication units, passing the request for non-real-time data to a wireless communication unit controller for further processing to obtain the requested non-real-time data from a content server.

14. The method of claim 13, wherein determining if the requested non-real-time data is stored in a cache of one of a plurality of other wireless communication units coupled to the first wireless communication unit comprises accessing an index server configured to maintain an index of the data stored on the cache of each of the plurality of other wireless communication units.

15. The method of claim 13, wherein determining if the requested non-real-time data is stored in a cache of one of a plurality of other wireless communication units coupled to the first wireless communication unit comprises passing the request for non-real-time data to a master wireless communication unit configured to maintain an index of the data stored on the cache of each of the plurality of other wireless communication units.

16. The method of claim 15, wherein providing the requested non-real-time data to the wireless device from the cache of the corresponding other wireless communication unit comprises providing information to the first wireless communication unit such that the first wireless communication unit is able to communicate with the other wireless communication unit which has the requested data stored in its cache.

17. The method of claim 16, wherein providing information to the first wireless communication unit comprises providing an Internet Protocol (IP) address of the other wireless communication unit which has the requested data stored in its cache.

18. The method of claim 13, wherein determining if the requested non-real-time data is stored in a cache of one of a plurality of other wireless communication units coupled to the first wireless communication unit comprises analyzing an index in the first wireless communication unit which indexes the data stored on the cache of each of the plurality of other wireless communication units.

19. The method of claim 18, further comprising updating the index in the first wireless communication unit when changes are made to the data stored on the cache of each of the plurality of other wireless devices.

20. The method of claim 19, wherein updating the index in the first wireless communication unit comprises one of:
receiving a notification at the first wireless device from the plurality of other wireless devices when changes are made to the respective cache of each of the plurality of other wireless devices; and
periodically requesting updates from each of the plurality of other wireless devices.

21. A method of caching non-real-time data in a first wireless communication unit having a local cache, the method comprising:
determining if a first non-real-time data is eligible to be cached;
if eligible, determining if the first non-real-time data is already cached on a cache of another wireless communication unit coupled to the first wireless communication unit; and
if the first non-real-time data is not cached on the cache of another wireless communication unit, caching the first non-real-time data on the cache of the first wireless communication unit.

22. The method of claim 21, wherein determining if the first non-real-time data is eligible to be cached comprises determining if the number of requests for the first non-real-time data exceeds a pre-determined number.

23. The method of claim 21, wherein determining if the first non-real-time data is already cached on a cache of another wireless communication unit comprises comparing the first non-real-time data with a local index of the non-real-time data cached in each of the other wireless communication units coupled to the first wireless communication unit.

24. The method of claim 21, further comprising notifying other wireless communication units coupled to the first wireless communication unit, that the first non-real-time data has been cached.
